(19) United States
(12) Patent Application Publication
(10) Pub. No.: US 2025/0392252 A1
(43) Pub. Date: Dec. 25, 2025

(54) ADJUSTABLE SOLAR TRACKER SUPPORT FRAME AND HANGING BEARING ASSEMBLY

(71) Applicant: Nextracker LLC, Fremont, CA (US)

(72) Inventors: Harry Van, Oakland, CA (US); Ryan Patel, Pleasanton, CA (US); Alexander W. AU, Oakland, CA (US); Ricardo Delgado-Nanez, San Jose, CA (US)

(21) Appl. No.: 19/215,721

(22) Filed: May 22, 2025

Related U.S. Application Data
(60) Provisional application No. 63/661,974, filed on Jun. 20, 2024.

(51) Int. Cl. H02S 20/32; F16C 35/04

(52) U.S. Cl. CPC H02S 20/32; F16C 35/042

(57) ABSTRACT

A solar tracker support frame assembly includes a multi-leg solar tracker support frame and a hanging bearing housing assembly. The multi-leg solar tracker support frame includes first and second frame legs and a bridge extending between the first and second frame legs. The hanging bearing housing assembly is at the multi-leg solar tracker support frame and is configured to support a torque tube. The hanging bearing housing assembly includes a bearing sleeve and a torque tube connector. The bearing sleeve includes a first bearing sleeve portion and a hanging bearing sleeve portion. The first bearing sleeve portion interfaces with the bridge, and the hanging bearing sleeve portion extends out from the first bearing sleeve portion below the bridge. The torque tube connector is configured to couple the torque tube to the hanging bearing housing assembly at least at the hanging bearing sleeve portion below the bridge.

### RELATED APPLICATION

This disclosure claims priority to U.S. Provisional Patent Application No. 63/661,974, filed Jun. 20, 2024, the content of which is hereby incorporated by reference.

### TECHNICAL FIELD

This disclosure relates generally to device, system, and method embodiments for solar tracker support frame assemblies and solar tracker bearing assemblies. Certain such embodiments disclosed herein relate to a multi-leg solar tracker support frame (e.g., a solar tracker A-frame) that can be adjusted relative to a ground surface and includes a hanging bearing housing assembly at the multi-leg solar tracker support frame. For instance, certain such embodiments disclosed herein include a hanging bearing assembly that is configured to be mounted at a multi-leg solar tracker support frame to position a torque tube at the hanging bearing assembly below an apex at the multi-leg solar tracker support frame (e.g., below a bridge of the multi-leg solar tracker support frame).

### BACKGROUND

Solar panels can convert sunlight into energy. As an example, solar photovoltaic panels convert sunlight directly into electricity for a variety of applications. Solar panels are generally composed of an array of solar cells, which are interconnected to each other. The cells are often arranged in series and/or parallel groups of cells in series.

Solar tracker systems can be used to dynamically orient a plurality of solar modules, for instance, by moving the solar modules throughout the course of a given day to track the movement of the sun and thereby increase the efficiency and productivity of the solar modules. Typical solar tracker systems installed in the field support the solar modules at the ground surface using a foundation at the ground surface. However, such typical solar tracker systems can necessitate a significant number of components and inter-component connections and fastening members to ultimately install the solar tracker system at the foundation at the ground surface.

### SUMMARY

This disclosure in general describes embodiments of devices, systems, and methods relating to solar tracker support frame assemblies. Such embodiments disclosed herein include solar tracker support frame assemblies having a multi-leg solar tracker support frame and a hanging bearing housing assembly at the multi-leg solar tracker support frame. Certain such embodiments disclosed herein relate to a multi-leg solar tracker support frame (e.g., a solar tracker A-frame) that can be adjusted relative to a ground surface, for instance that can be adjusted relative to a ground surface in a north-south direction relative to the ground surface. Certain such additional or alternative embodiments disclosed herein relate to a hanging bearing assembly that is configured to be mounted at a multi-leg solar tracker support frame to position a torque tube at the hanging bearing assembly below an apex at the multi-leg solar tracker support frame (e.g., below a bridge of the multi-leg solar tracker support frame).

Such embodiments disclosed herein can be useful in reducing the cost, time, and labor associated with installing a solar tracker system in the field. For example, such embodiments disclosed herein can be adapted for use with a wide variety of foundation types. As another example, these embodiments disclosed herein can help to reduce the cost of solar tracker installation in the field by reducing a number of components and inter-component connections and fastening members necessary to effectively couple a torque tube of a solar tracker system to a hanging bearing housing assembly that is supported by a multi-leg solar tracker support frame at a foundation. And as another example, such embodiments disclosed herein can include the hanging bearing housing assembly configured to be mounted at a multi-leg solar tracker support frame to position a torque tube at the hanging bearing assembly below an apex at the multi-leg solar tracker support frame. This can lower the elevation of the torque tube and rotational axis of the solar tracker system, which in turn can help to reduce the magnitude of dynamic loads (e.g., wind loads) transferred to the foundation which can help to reduce the cost and complexity associated with foundations that would otherwise need to support the greater magnitude dynamic loads resulting from a higher-elevation positioning of the torque tube.

One embodiment includes a solar tracker support frame assembly. This solar tracker support frame assembly includes a multi-leg solar tracker support frame and a hanging bearing housing assembly. The multi-leg solar tracker support frame includes a first frame leg, a second frame leg, and a bridge extending between the first frame leg and the second frame leg. The hanging bearing housing assembly is at the multi-leg solar tracker support frame, and the hanging bearing housing assembly is configured to support a torque tube. The hanging bearing housing assembly includes a bearing sleeve and a torque tube connector. The bearing sleeve includes a first bearing sleeve portion and a hanging bearing sleeve portion. The first bearing sleeve portion interfaces with the bridge, and the hanging bearing sleeve portion extends out from the first bearing sleeve portion below the bridge. The torque tube connector is configured to couple the torque tube to the hanging bearing housing assembly at least at the hanging bearing sleeve portion below the bridge.

In a further embodiment of this assembly, the first bearing sleeve portion can wrap around at least a portion of the bridge. For example, the first bearing sleeve portion can wrap around at least half of a perimeter surface of the bridge. For some embodiments, the first bearing sleeve portion can define an apex at the multi-leg solar tracker support frame.

In a further embodiment of this assembly, the hanging bearing sleeve portion can include a first hanging bearing sleeve portion at a first side of the bridge and a second hanging bearing sleeve portion at a second, opposite side of the bridge. The first hanging bearing sleeve portion can include a first torque tube connector aperture at the first side of the bridge, and the second hanging bearing sleeve portion can include a second torque tube connector aperture at the second, opposite side of the bridge. For instance, the first torque tube connector aperture can be at the first side of the bridge and the second torque tube connector aperture can be at the second, opposite side of the bridge are aligned on a connector aperture axis.

In a further embodiment of this assembly, the torque tube connector includes a pin. In a yet further embodiment, the assembly further includes a U-bolt that is configured to couple the pin to the torque tube. In one such example, the pin extends through the first torque tube connector aperture at the first side of the bridge and the second torque tube connector aperture at the second side of the bridge, and the pin couples to a pin aperture at the U-bolt. As another additional or alternative example, the pin can extend along a pin longitudinal axis that is offset from a longitudinal axis of the torque tube.

In a further embodiment of this assembly, the torque tube connector can include a bearing housing that defines a torque tube receptacle extending through the bearing housing from the first torque tube connector aperture at the first side of the bridge to the second torque tube connector aperture at the second side of the bridge. For example, the bearing housing can extend below the bridge to suspend the torque tube receptacle below the bridge. Additionally, for some embodiments, the first bearing sleeve portion can include a yaw interface that is configured to twist the bearing sleeve relative to the bridge.

In a further embodiment of this assembly, at least one of the first frame leg and the second frame leg can include a leg angular adjustment adapter. The leg angular adjustment adapter can be configured to change an angular orientation of the at least one of the first frame leg and the second frame leg relative to a ground surface. For example, the leg angular adjustment adapter can be configured to change the angular orientation of the at least one of the first frame leg and the second frame leg relative to the ground surface in a north-south direction relative to the ground surface. Some such embodiments can include the leg angular adjustment adapter at each of the first frame leg and the second frame leg. As one particular such example, each of the first frame leg and the second frame leg can include a foundation connector that is configured to couple to a foundation component embedded in the ground surface. The leg angular adjustment adapter can be at the foundation connector at each of the first frame leg and the second frame leg. In some instances, the leg angular adjustment adapter can be configured to provide a hard stop at the foundation connector when the respective first frame leg and second frame leg is at a preset angular orientation relative to the ground surface.

Another embodiment includes a hanging bearing housing assembly that is configured to support a torque tube. This hanging bearing housing assembly embodiment includes a bearing sleeve and a torque tube connector. The bearing sleeve includes a first bearing sleeve portion and a hanging bearing sleeve portion. The first bearing sleeve portion is configured to define an apex at a multi-leg solar tracker support frame when the hanging bearing housing assembly is coupled to the multi-leg solar tracker support frame. The hanging bearing sleeve portion extends out below the first bearing sleeve portion when the hanging bearing housing assembly is coupled to the multi-leg solar tracker support frame. The torque tube connector is configured to couple the torque tube to the hanging bearing housing assembly at the hanging bearing sleeve portion below the bridge.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic, elevational view diagram of a solar tracker system that includes a plurality of solar tracker support frame assemblies.

FIGS. 2A-2C illustrate one exemplary embodiment of a solar tracker support frame assembly coupled to a torque tube of a solar tracker system. FIG. 2A is a schematic, elevational view diagram of the solar tracker support frame assembly embodiment, FIG. 2B is a perspective view of the solar tracker support frame assembly embodiment, and FIG. 2C is a top plan view of the solar tracker support frame assembly embodiment.

FIGS. 3A-3E illustrate another exemplary embodiment of a solar tracker support frame assembly coupled to a torque tube of a solar tracker system. FIG. 3A is an exploded, assembly view of a hanging bearing housing assembly embodiment of the solar tracker support frame assembly embodiment relative to a bridge of a multi-leg solar tracker support frame of the solar tracker support frame assembly. FIG. 3B is an end elevational view of the solar tracker support frame assembly embodiment with the hanging bearing housing assembly embodiment assembled at the bridge of the multi-leg solar tracker support frame.

FIG. 3C is a side elevational view (e.g., ninety degrees rotated from the end view of FIG. 3B) of the solar tracker support frame assembly embodiment assembled at the bridge of the multi-leg solar tracker support frame. FIG. 3D is a perspective view of the assembled hanging bearing housing assembly embodiment at the bridge of the multi-leg solar tracker support frame. FIG. 3E is a top plan view of a yaw interface at a bearing sleeve of the hanging bearing housing assembly embodiment.

FIGS. 4A-4E illustrate one exemplary embodiment of leg angular adjustment adapter at a leg of a multi-leg solar tracker support frame of a solar tracker support frame assembly. FIG. 4A is an exploded, assembly view of the leg angular adjustment adapter at the leg of the multi-leg solar tracker support frame. FIG. 4B is a perspective view of the leg angular adjustment adapter assembled at the leg of the multi-leg solar tracker support frame. FIG. 4C is an elevational view of the leg of the multi-leg solar tracker support frame with the leg angular adjustment adapter hard-stopped at a preset angular orientation relative to a ground surface. FIG. 4D is an elevational view of an adapter component having an embodiment of a hard stop. FIG. 4E is an elevation view showing the leg of the multi-leg solar tracker support frame with the leg angular adjustment adapter hard-stopped at a preset angular orientation relative to a ground surface via the hard stop at the adapter component.

FIGS. 5A-5E illustrate another exemplary embodiment of leg angular adjustment adapter at a leg of a multi-leg solar tracker support frame of a solar tracker support frame assembly. FIG. 5A is an exploded, assembly view of the leg angular adjustment adapter at the leg of the multi-leg solar tracker support frame. FIG. 5B is a perspective view of the leg angular adjustment adapter assembled at a foundation component using a foundation connector at the leg of the multi-leg solar tracker support frame. FIG. 5C is a perspective view of an end portion of a foundation component having a complementary connector, and FIG. 5D is a perspective view of the foundation connector at the leg of the multi-leg solar tracker support frame. FIG. 5E is an elevational view showing the leg of the multi-leg solar tracker support frame with the foundation connector at the leg hard-stopped at a preset angular orientation relative to a ground surface via a hard stop at the foundation component's complementary connector.

FIGS. 6A-6E illustrate another exemplary embodiment of leg angular adjustment adapter at a leg of a multi-leg solar tracker support frame of a solar tracker support frame assembly. FIG. 6A is an exploded, assembly view of the leg angular adjustment adapter at the leg of the multi-leg solar tracker support frame. FIG. 6B is a perspective view of the leg angular adjustment adapter assembled at a foundation component using a foundation connector at the leg of the multi-leg solar tracker support frame. FIG. 6C is a perspective view of an end portion of a foundation component having a complementary connector, and FIG. 6D is a perspective view of the foundation connector at the leg of the multi-leg solar tracker support frame. FIG. 6E is an elevational view showing the leg of the multi-leg solar tracker support frame with the foundation connector at the leg hard-stopped at a preset angular orientation relative to a ground surface via a hard stop at the foundation component's complementary connector.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods relating to solar tracker support frame assemblies. Such embodiments disclosed herein include solar tracker support frame assemblies having a multi-leg solar tracker support frame and a hanging bearing housing assembly at the multi-leg solar tracker support frame. Certain such embodiments disclosed herein relate to a multi-leg solar tracker support frame (e.g., a solar tracker A-frame) that can be adjusted relative to a ground surface. Certain such additional or alternative embodiments disclosed herein relate to a hanging bearing assembly that is configured to be mounted at a multi-leg solar tracker support frame to position a torque tube at the hanging bearing assembly below an apex at the multi-leg solar tracker support frame (e.g., below a bridge of the multi-leg solar tracker support frame). These embodiments can be useful in reducing cost, time, and labor associated with installing a solar tracker system in the field.

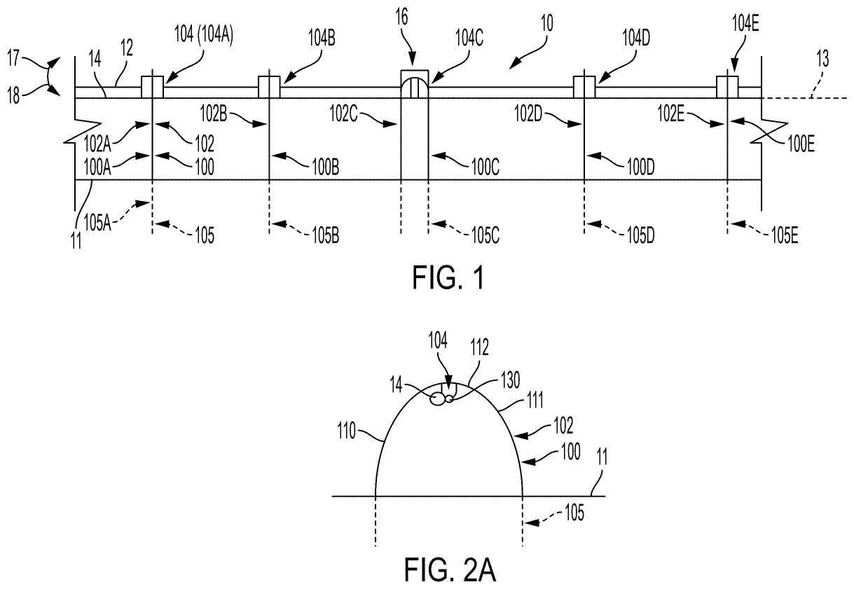

FIG. 1 is a schematic, elevational view diagram of a solar tracker system 10. The solar tracker system 10 includes a torque tube 14 and a plurality of solar modules 12 that are coupled to the torque tube 14 to thereby rotate with the torque tube 14. The system 10 can further include a motive source 16 that is coupled to the torque tube 14 to impart a rotational motive force (e.g., torque) to the torque tube 14 to cause the torque tube 14 to rotation in a direction 17 and in an opposite direction 18. The system 10 can be configured to rotate the torque tube 14 in directions 17, 18 over time to change the orientation of the solar modules 12 relative to the sun.

Each of the one of more solar modules 12 can include a frame and a plurality of photovoltaic cells that are configured to receive sunlight and as a result generate electrical energy. A module mounting assembly can connect at least one solar module 12 to the torque tube 14, and the torque tube can be configured to rotatably move one or more such solar modules 12. For instance, the torque tube 14 can be actuated by a controller (e.g., that is in communication with the motive source 16) to cause the torque tube 14 to move, such as rotate about a longitudinal axis 13 of the torque tube 14. Rotation of the torque tube 14 in the directions 17 and/or 18 can facilitate more optimized solar power generation at the photovoltaic cells at the solar modules 12 by adjusting the angle of the one or more solar modules at one or more times (e.g., at times during a given day) to help “track” the sun as it moves over that period of time and, thereby, maintain more optimized positioning of the photovoltaic cells relative to the angle of sunlight irradiation at that given time of the day.

To support the torque tube 14, the system 10 can include a plurality of solar tracker support frame assemblies 100. The embodiment illustrated at FIG. 1 shows a plurality of solar tracker support frame assemblies 100A, 100B, 100C, 100D, 100E each rotatably supporting torque tube 14. Each solar tracker support frame assembly 100 can include a multi-leg solar tracker support frame 102 and a hanging bearing housing assembly 104. Thus, as shown at the example of FIG. 1, the solar tracker support frame assembly 100A includes the multi-leg solar tracker support frame 102A and the hanging bearing housing assembly 104A, the solar tracker support frame assembly 100B includes the multi-leg solar tracker support frame 102B and the hanging bearing housing assembly 104B, the solar tracker support frame assembly 100C includes the multi-leg solar tracker support frame 102C and the hanging bearing housing assembly 104C, the solar tracker support frame assembly 100D includes the multi-leg solar tracker support frame 102D and the hanging bearing housing assembly 104D, and the solar tracker support frame assembly 100E includes the multi-leg solar tracker support frame 102E and the hanging bearing housing assembly 104E. The respective hanging bearing housing assembly 104A-104E at each solar tracker support frame assembly 100A-100E can receive and rotatably support the torque tube 14 thereat. Thus, the torque tube 14 can rotate in the directions 17, 18 while rotatably supported at each of the hanging bearing housing assemblies 104A-104E. The respective multi-leg solar tracker support frame 102A-102E at each solar tracker support frame assembly 100A-100E can couple to the respective hanging bearing housing assembly 104A-104E.

Each of the respective multi-leg solar tracker support frames 102A-102E can be supported at a ground surface 11 via a foundation component 105. As shown at FIG. 1, the multi-leg solar tracker support frame 102A is supported at ground surface 11 via foundation component 105A, the multi-leg solar tracker support frame 102B is supported at ground surface 11 via foundation component 105B, the multi-leg solar tracker support frame 102C is supported at ground surface 11 via foundation component 105C, the multi-leg solar tracker support frame 102D is supported at ground surface 11 via foundation component 105D, and the multi-leg solar tracker support frame 102E is supported at ground surface 11 via foundation component 105E. The foundation components 105A-105E can extend into and below ground surface 11 so as to be embedded into the ground surface 11 to support the above-ground, respective multi-leg solar tracker support frame 102A-102E and associated respective hanging bearing housing assembly 104A-104E. The foundation components 105A-105E can, for example, one or more blade piles (e.g., a pair of blade piles), one or more screw piles (e.g., a pair of screw piles), and/or one or more concrete footings (e.g., a pair of concrete footings) as examples.

FIG. 1 shows the system 10 at a side elevational view looking in an east-west orientation at the multi-leg solar tracker support frames 102A-102E and associated hanging bearing housing assemblies 104A-104E. As illustrated, the multi-leg solar tracker support frames 102A, 102B, 102D, 102E and associated hanging bearing housing assemblies 104A, 104B, 104D, 104E can be oriented in one direction, while the multi-leg solar tracker support frame 102C associated hanging bearing housing assembly 104C can be oriented in a different direction, such as generally ninety degrees offset from the multi-leg solar tracker support frames 102A, 102B, 102D, 102E. For instance, the multi-leg solar tracker support frames 102A, 102B, 102D, 102E and associated hanging bearing housing assemblies 104A, 104B, 104D, 104E can face one of east-west and north-south while the multi-leg solar tracker support frame 102C and associated hanging bearing housing assembly 104C can face the other of east-west and north-south.

Installing a typical solar tracker system in the field can oftentimes necessitate a significant number of interconnections between a significant number of components ranging from subterranean foundation components and connections to above-ground bearing connections and solar module support connections. The solar tracker support frame assembly 100 embodiments disclosed herein can be useful in reducing the cost, time, and labor associated with installing a solar tracker system in the field. For example, such embodiments disclosed herein can be adapted for use with a wide variety of foundation types, can help to reduce the cost of solar tracker installation in the field by reducing a number of components and inter-component connections and fastening members necessary to effectively couple a torque tube of a solar tracker system to a hanging bearing housing assembly that is supported by a multi-leg solar tracker support frame at a foundation, and/or can include the hanging bearing housing assembly configured to be mounted at a multi-leg solar tracker support frame to position a torque tube at the hanging bearing assembly below an apex at the multi-leg solar tracker support frame to thereby help to reduce the magnitude of dynamic loads (e.g., wind loads) transferred to the foundation component.

For example, to hep reduce cost, time, and labor associated with installing a solar tracker system in the field, embodiments disclosed herein can include solar tracker support frame assemblies having a multi-leg solar tracker support frame and a hanging bearing housing assembly at the multi-leg solar tracker support frame. The multi-leg solar tracker support frame (e.g., a solar tracker A-frame) can be adjusted relative to a ground surface and/or the hanging bearing assembly is configured to be mounted at a multi-leg solar tracker support frame to position a torque tube at the hanging bearing assembly below an apex at the multi-leg solar tracker support frame (e.g., below a bridge of the multi-leg solar tracker support frame).

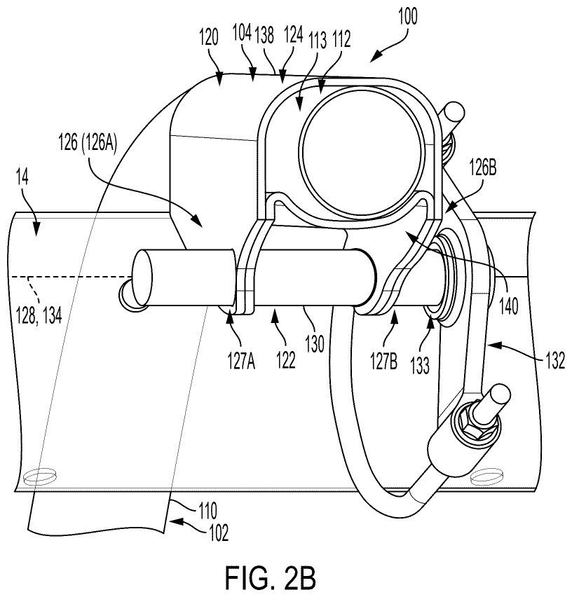

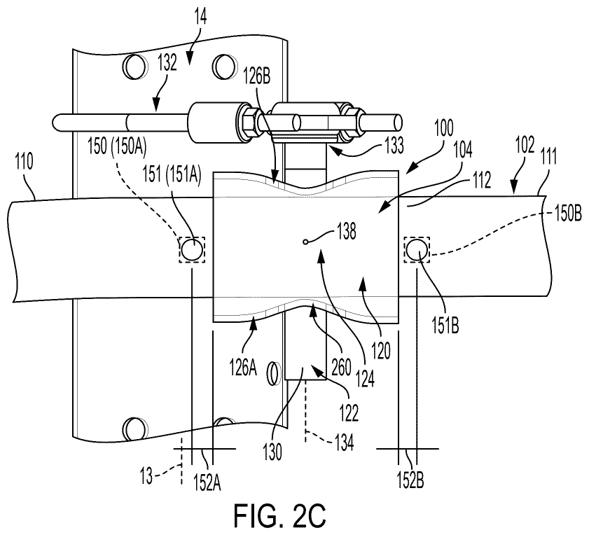

FIGS. 2A-2C illustrate one exemplary embodiment of solar tracker support frame assembly 100 coupled to torque tube 14. FIG. 2A is a schematic, elevational view diagram of the solar tracker support frame assembly 100, FIG. 2B is a perspective view of the solar tracker support frame assembly 100, and FIG. 2C is a top plan view of the solar tracker support frame assembly 100.

The solar tracker support frame assembly 100 includes the multi-leg solar tracker support frame 102 and the hanging bearing housing assembly 104. The solar tracker support frame assembly 100 can be supported at ground surface 11 via one or more foundation components 105. As shown here, the solar tracker support frame assembly 100 can be supported at ground surface 11 via a pair of foundation components 105. The one or more foundation components 105 can extend into and below ground surface 11 to anchor the solar tracker support frame assembly 100 to the ground surface 11. The one or more foundation components 105 can be any of a variety of types of suitable subterranean anchor components that can be embedded in the ground and coupled to the solar tracker support frame assembly 100.

The multi-leg solar tracker support frame 102 can include a first frame leg 110, a second frame leg 111, and a bridge 112 extending between the first frame leg 110 and the second frame leg 111. The first frame leg 110 and the second frame leg 111 can be supported at the ground surface 11 via foundation component 105 that is at least partially embedded within the ground surface 11. As shown for the illustrated example, the first frame leg 110 can be supported at a first foundation component 105 that is at least partially embedded within the ground surface 11 while the second frame leg 111 can be supported at a second, different foundation component 105 that is at least partially embedded within the ground surface 11. The bridge 112 can bridge between and interconnect the first and second frame legs 110, 111. In some examples, the multi-leg solar tracker support frame 102 can have the first frame leg 110, the second frame leg 111, and the bridge 112 as integral components defining a single piece body at the multi-leg solar tracker support frame 102, though in other examples the multi-leg solar tracker support frame 102 can have the first frame leg 110, the second frame leg 111, and the bridge 112 as individual components that are fastened together, such as via the bridge 112. The one or more foundation components 105 can be inserted (e.g., rammed, rotationally driven, etc.) into ground surface 11 and then the multi-leg solar tracker support frame 102 can be coupled to the ground embedded one or more foundation components 105.

The hanging bearing housing assembly 104 can be at the multi-leg solar tracker support frame 102. The hanging bearing housing assembly 104 can be configured to support the torque tube 14 such that the torque tube 14 is supported via the ground surface 11 by the foundation component(s) 105, the multi-leg solar tracker support frame 102, and the hanging bearing housing assembly 104. For example, the hanging bearing housing assembly 104 can be configured to rotatably support the torque tube 14 thereat such that the torque tube 14 can rotate relative to the hanging bearing housing assembly 104 to change an orientation of solar modules relative to the sun. The hanging bearing housing assembly 104 can include a bearing sleeve 120 and a torque tube connector 122. The bearing sleeve 120 can be configured to suspend the torque tube connector 122 from the multi-leg solar tracker support frame 102, and the suspended torque tube connector 122 can be configured to couple to the torque tube 14 so as to rotatably support the torque tube 14 at the hanging bearing housing assembly 104. As shown for the illustrated example, the torque tube 14 can be suspended from the hanging bearing housing assembly 104 below the bridge 112 such that the torque tube 14 passes between the legs 110, 111 as the torque tube 14 passes under the bridge 112.

The bearing sleeve 120 at the hanging bearing housing assembly 104 can include a first bearing sleeve portion 124 and a hanging bearing sleeve portion 126. The first bearing sleeve portion 124 can be configured to interface with the bridge 112, and the hanging bearing sleeve portion 126 can be configured to extend out from the first bearing sleeve portion 124 below the bridge 112. The illustrated embodiment shows that the first bearing sleeve portion 124 can wrap around at least a portion of the bridge 112. For instance, as shown best at the example of FIG. 2B, the first bearing sleeve portion 124 can be configured to wrap around at least half of a perimeter surface 113 of the bridge 112. The first bearing sleeve portion 124 can define an apex 138 at the multi-leg solar tracker support frame 102 such that the apex 138 at the first bearing sleeve portion 124 is at a height relative to the ground surface 11 above a highest elevation portion of the multi-leg solar tracker support frame 102. The hanging bearing sleeve portion 126 can be configured to couple to the torque tube connector 122 so as to couple the torque tube 14 to the bearing sleeve 120 at the hanging bearing sleeve portion 126. For instance, as shown for the example here, the torque tube connector 122 can be configured to couple the torque tube 14 to the hanging bearing housing assembly 104 at least at the hanging bearing sleeve portion 126 below the bridge 112 of the multi-leg solar tracker support frame 102.

For example, the hanging bearing sleeve portion 126 can include a first hanging bearing sleeve portion 126A at a first side of the bridge 112 and a second hanging bearing sleeve portion 126B at a second, opposite side of the bridge 112. The first hanging bearing sleeve portion 126A can include a first torque tube connector aperture 127A at the first side of the bridge 112, and the second hanging bearing sleeve portion 126B comprises a second torque tube connector aperture 127B at the second, opposite side of the bridge 112. For instance, in one specific such example shown here, the first torque tube connector aperture 127A at the first side of the bridge 112 and the second torque tube connector aperture 127B at the second, opposite side of the bridge 112 can aligned on a connector aperture axis 128. The first and second torque tube connector apertures 127A, 127B can be configured to receive the torque tube connector 122 such that the torque tube connector 122 extends through the first and second torque tube connector apertures 127A, 127B at the hanging bearing sleeve portion 126 below the bridge 112 of the multi-leg solar tracker support frame 102.

The torque tube connector 122 of the illustrated embodiment of the hanging bearing housing assembly 104 includes a pin 130. As also shown for the illustrated embodiment at FIGS. 2A-2C, the solar tracker support frame assembly 100 can also include a U-bolt 132. The U-bolt 132 can be configured to receive and couple the pin 130 to the torque tube 14. For example, the pin 130 can extend through the first torque tube connector aperture 127A, at the first side of the bridge 112, extend through the second torque tube connector aperture 127B, at the second side of the bridge 112, and pass under the bridge 112 opposite the first bearing sleeve portion 124. The U-bolt 132 can receive and couple to the pin 130 via a pin aperture 133 at the U-bolt 132. As shown at the examples at FIGS. 2B and 2C, the pin 130 can extend along a pin longitudinal axis 134 that is offset from central longitudinal axis 13 of the torque tube (e.g., with torque tube central longitudinal axis 13 being the rotational axis of the torque tube 14).

As illustrated at the example at FIGS. 2A-2C, the hanging bearing housing assembly 104 can further include a sub-bridge retainer 140. The sub-bridge retainer 140 can be configured to sit below the bridge 112 at the multi-leg solar tracker support frame 102 and between the hanging bearing sleeve portion 126. The pin 130 can be configured to extend through the first hanging bearing sleeve portion 126A at one side of the bridge 112, then through a first side of the sub-bridge retainer 140 at the one side of the bridge 112, then through a second, opposite side of the sub-bridge retainer 140 at another opposite side of the bridge 112, and then through the second hanging bearing sleeve portion 126B at the another opposite side of the bridge 112. The sub-bridge retainer 140 can be configured to increase the structural support at the hanging bearing housing assembly 104 on the pin 130 and/or to help prevent misalignment between or pulling-off of the pin 130 and the hanging bearing sleeve portion 126.

Also shown at the example at FIG. 2C are one or more lateral stops 150 at the multi-leg solar tracker support frame 102. The one or more lateral stops 150 can be received at one or more corresponding stop apertures 151 defined at the multi-leg solar tracker support frame 102. FIGS. 2C shows two lateral stops 150A, 150B at the multi-leg solar tracker support frame 102, with first lateral stop 150A and first stop aperture 151A at one side of the first bearing sleeve portion 124 and second lateral stop 150B and second stop aperture 151B at another, opposite side of the first bearing sleeve portion 124. More specifically, the illustrated embodiment shows first lateral stop 150A at bridge 112 at one side of the first bearing sleeve portion 124 and second lateral stope 150B at bridge 112 at another, opposite side of the first bearing sleeve portion 124. The bridge 112 can include the first stop aperture 151A at a distance 152A from the adjacent side of the first bearing sleeve portion 124 and the second stop aperture 151B at a distance 152B from the opposite, adjacent side of the first bearing sleeve portion 124. The distances 152A, 152B can be less than two inches, such as less than one inch, or such as less than 0.6 inches. The one or more lateral stops 150 can be configured to provide an interference structure at the bridge 112 that, when contacted by the first bearing sleeve portion 124, impedes or prevents lateral movement of the first bearing sleeve portion 124 relative to the bridge 112 past the lateral stop 150.

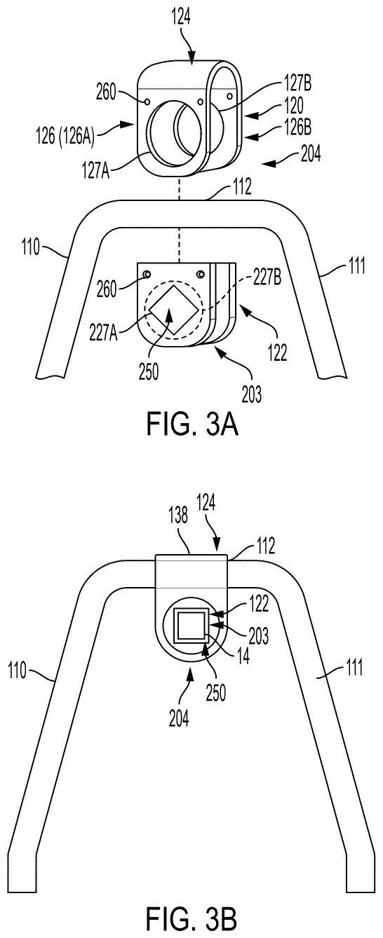

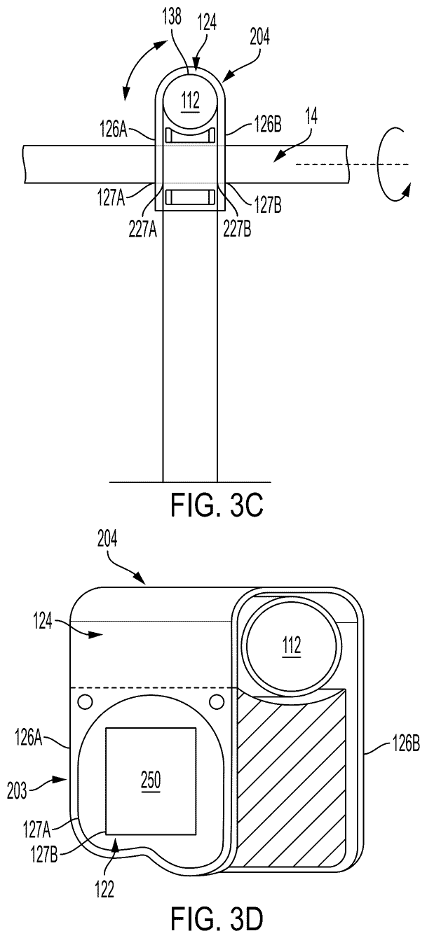

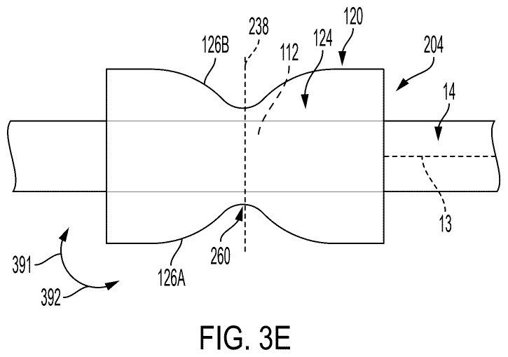

FIGS. 3A-3E illustrate another exemplary embodiment of a solar tracker support frame assembly 200 coupled to torque tube 14 of a solar tracker system. For instance, the solar tracker support frame assembly 200 can be similar to, or the same as, the solar tracker support frame assembly 100 described previously herein in references to FIGS. 2A-2C except as otherwise noted below. As one such example, the solar tracker support frame assembly 200 at FIGS. 3A-3E can have the multi-leg solar tracker support frame 102 as disclosed in reference to FIGS. 2A-2C, but the solar tracker support frame assembly 200 at FIGS. 3A-3E can have a different embodiment of hanging bearing housing assembly than that disclosed in reference to FIGS. 2A-2C. In particular, as shown and described in reference to the solar tracker support frame assembly 200 embodiment at FIGS. 3A-3E, hanging bearing housing assembly 204 of the solar tracker support frame assembly 200 embodiment at FIGS. 3A-3E can replace and/or augment pin 130 with bearing housing 203 that includes a torque tube receptacle 250. FIG. 3A is an exploded, assembly view of the hanging bearing housing assembly 204 of the solar tracker support frame assemble 200 relative to bridge 112 of multi-leg solar tracker support frame 102 of the solar tracker support frame assembly 200. FIG. 3B is an end elevational view of the solar tracker support frame assembly 200 with the hanging bearing housing assembly 204 assembled at the bridge 112 of the multi-leg solar tracker support frame 102. FIG. 3C is a side elevational view (e.g., ninety degrees rotated from the end view of FIG. 3B) of the solar tracker support frame assembly 200 assembled at the bridge 112 of the multi-leg solar tracker support frame 102. FIG. 3D is a perspective view of the assembled hanging bearing housing assembly 204 at the bridge 112 of the multi-leg solar tracker support frame 102.

The hanging bearing housing assembly 204 can be at the multi-leg solar tracker support frame 102. The hanging bearing housing assembly 204 can be configured to support the torque tube 14 such that the torque tube 14 is supported via the ground surface 11 by the foundation component(s), the multi-leg solar tracker support frame 102, and the hanging bearing housing assembly 204. For example, the hanging bearing housing assembly 204 can be configured to rotatably support the torque tube 14 thereat such that the torque tube 14 can rotate relative to the hanging bearing housing assembly 204 to change an orientation of solar modules relative to the sun. The hanging bearing housing assembly 204 can include bearing sleeve 120 and torque tube connector 122. The bearing sleeve 120 can be configured to suspend the torque tube connector 122 from the multi-leg solar tracker support frame 102, and the suspended torque tube connector 122 can be configured to couple to the torque tube 14 so as to rotatably support the torque tube 14 at the hanging bearing housing assembly 204. As shown for the illustrated example, the torque tube 14 can be suspended from the hanging bearing housing assembly 204 below the bridge 112 such that the torque tube 14 passes between the legs 110, 111 as the torque tube 14 passes under the bridge 112.

The bearing sleeve 120 at the hanging bearing housing assembly 204 can include the first bearing sleeve portion 124 and the hanging bearing sleeve portion 126, with the first bearing sleeve portion 124 configured to interface with the bridge 112 and the hanging bearing sleeve portion 126 configured to extend out from the first bearing sleeve portion 124 below the bridge 112, as disclosed previously herein. The first bearing sleeve portion 124 can define apex 138 at the multi-leg solar tracker support frame 102 such that the apex 138 at the first bearing sleeve portion 124 is at a height relative to the ground surface above a highest elevation portion of the multi-leg solar tracker support frame 102. The hanging bearing sleeve portion 126 can be configured to couple to the torque tube connector 122 so as to couple the torque tube 14 to the bearing sleeve 120 at the hanging bearing sleeve portion 126.

For example, the hanging bearing sleeve portion 126 can include a first hanging bearing sleeve portion 126A at a first side of the bridge 112 and a second hanging bearing sleeve portion 126B at a second, opposite side of the bridge 112. The first hanging bearing sleeve portion 126A can include first torque tube connector aperture 127A at the first side of the bridge 112, and the second hanging bearing sleeve portion 126B comprises second torque tube connector aperture 127B at the second, opposite side of the bridge 112. The first and second torque tube connector apertures 127A, 127B can be configured to receive therebetween the torque tube connector 122. When the torque tube connector 122 is received at the hanging bearing sleeve portions 126A, 126B, the torque tube connector 122 can be fastened to the bearing sleeve 120 via complementary fastening apertures 260 at each of the bearing sleeve 120 and the torque tube connector 122, with the torque tube connector 122 extending between the first and second torque tube connector apertures 127A, 127B at the hanging bearing sleeve portions 126A, 126B below the bridge 112 of the multi-leg solar tracker support frame 102.

The torque tube connector 122 of the illustrated embodiment of the hanging bearing housing assembly 204 includes a bearing housing 203. The bearing housing 203 can define torque tube receptacle 250 that extends through the bearing housing 203 from first torque tube connector aperture 227A at one side of the bearing housing 203 to the second torque tube connector aperture 227B at another, opposite side of the bearing housing 203. When the bearing housing 203 is coupled to the bearing sleeve 120, such as shown at the example of FIG. 3C, torque tube 14 can be received underneath bridge 112 at torque tube receptacle 250 defined: (i) at a first side of the bridge 112 at each of the first torque tube connector aperture 127A at the hanging bearing sleeve portion 126A at the bearing sleeve 120 and at the first torque tube connector aperture 227A at the bearing housing 203, and (ii) at a second, opposite side of the bridge 112 at each of the second torque tube connector aperture 127B at the hanging bearing sleeve portion 126B at the bearing sleeve 120 and at the second torque tube connector aperture 227B at the bearing housing 203. Thus, the bearing housing 203 can extend below the bridge 112 to suspend the torque tube receptacle 250 below the bridge 112.

FIG. 3E is a top plan view of a yaw interface 260 at bearing sleeve 120 of hanging bearing housing assembly 204. While described here in reference to the bearing housing assembly 204, it is to be noted that the yaw interface 260 can also be present at other bearing housing assembly embodiments disclosed herein (e.g., as shown for the bearing housing assembly 104 at FIG. 2C). The yaw interface 260, at the first bearing sleeve portion 124, can be configured to twist the bearing sleeve 120 relative to the bridge 112. For instance, the first bearing sleeve portion 124, which can define the apex 138, can be bisected by bisection axis 238. The yaw interface 260 can be configured to rotate the first bearing sleeve portion 124 in directions 391, 392 relative to the bridge 112, for instance, while the torque tube 14 is received at the hanging bearing housing assembly 204 and suspended below the bridge 112.

Having described features of embodiments of hanging bearing housing assemblies above, the following will describe certain features of embodiments of multi-leg solar tracker support frames. For some applications, any one or more of the multi-leg solar tracker support frame features and embodiments disclosed herein can be sued with any one or more of the hanging bearing housing assembly features embodiments disclosed herein.

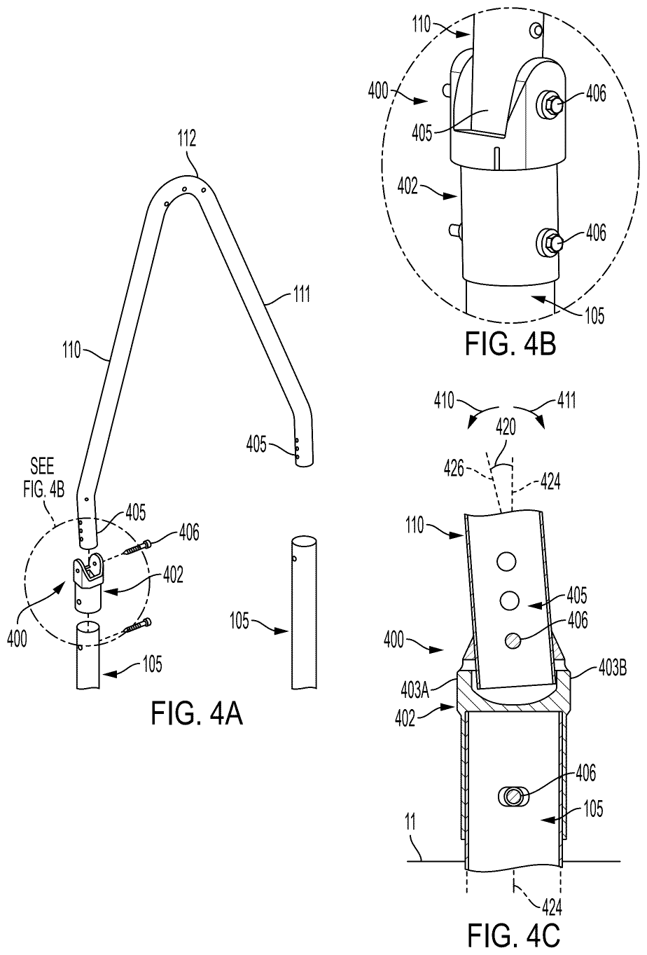

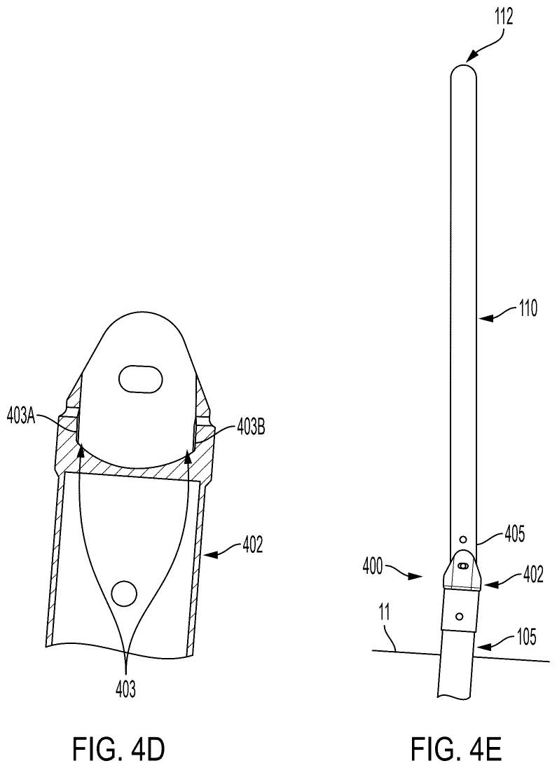

FIGS. 4A-4E illustrate one exemplary embodiment of leg angular adjustment adapter 400. For example, the leg angular adjustment adapter 400 can be at leg 110 and/or 111 of multi-leg solar tracker support frame 102 of solar tracker support frame assembly 100. Thus, in some exemplary applications the leg angular adjustment adapter 400 can be included at the solar tracker support frame assembly 100 and used, for instance, in conjunction with an embodiment of a hanging bearing housing assembly, such as any one or more of those disclosed herein.

FIG. 4A is an exploded, assembly view of the leg angular adjustment adapter 400 at leg 110 of the multi-leg solar tracker support frame 102, and FIG. 4B is a perspective view of the leg angular adjustment adapter 400 assembled at the leg 110 of the multi-leg solar tracker support frame 102. The illustrated embodiment shows the leg angular adjustment adapter 400 at leg 110, though other embodiments can include the leg angular adjustment adapter 400 at the leg 111 in addition to, or alternative to, the leg angular adjustment adapter 400 at leg 110. Thus, some embodiments can include the leg angular adjustment adapter 400 at both leg 110 and leg 111 of the multi-leg solar tracker support frame 102.

The leg angular adjustment adapter 400 can be configured to change an angular orientation of the at least one of the first frame leg 110 and the second frame leg 111 relative to ground surface 11. For example, the leg angular adjustment adapter 400 can be configured to change the angular orientation of the at least one of the first frame leg 110 and the second frame leg 111 relative to the ground surface 11 in a north-south direction relative to the ground surface 11. For instance, referring to FIG. 1, the leg angular adjustment adapter 400 can be included at the leg 110 and/or leg 111 of any one or more of the multi-leg solar tracker support frames 102A, 102B, 102D, 102E to change the angular orientation of the at least one of the first frame leg 110 and the second frame leg 111 relative to the ground surface 11 in a north-south direction relative to the ground surface 11.

The illustrated embodiment of the leg angular adjustment adapter 400 includes adapter component 402. The adapter component 402 can be configured to hingedly connect the frame leg 110 or 111 to foundation component 105, for instance, via pins 406 or other appropriate fasteners between the adapter component 402 and the frame leg 110 or 111 and/or fasteners between the adapter component 402 and foundation component 105. Thus, the frame leg 110 or 111 can be configured to rotate relative to the foundation component 105 about the adapter component 402. For example, the frame leg 110 or 111 can be configured to rotate in first direction 410 (e.g., north) relative to the foundation component 105 about the adapter component 402, and the frame leg 110 or 111 can be configured to rotate in second, opposite direction 411 (e.g., south) relative to the foundation component 105 about the adapter component 402. For various embodiments, each of frame leg 110 and 111 can include a foundation connector 405. The foundation connector 405 can be configured to be coupled to foundation component 105. For the illustrated embodiment of the leg angular adjustment adapter 400 that includes the hinged adapter component 402, the foundation connector 405 can be configured to couple to foundation component 105 indirectly via the hinged adapter component 402. Thus, the first frame leg 110 and/or the second frame leg 111 can include foundation connector 405, and foundation connector 405 can be configured to couple to foundation component 105 that is itself embedded in ground surface 11. As shown for the embodiment illustrated here, the leg angular adjustment adapter 400 can be at the foundation connector 405 at the first frame leg 110 and/or the second frame leg 111.

In addition to the leg angular adjustment adapter 400 being configured to rotate the leg 110 or 111 relative to the ground surface 11 and foundation component 105, the leg angular adjustment adapter 400 can be configured to provide a hard stop 403 to impede or prevent further rotation of the respective leg 110 or 111 relative to the ground surface 11 and foundation component 105. For example, the leg angular adjustment adapter 400 can be configured to rotate the leg 110 or 111 relative to the ground surface 11 and foundation component 105 in direction 410 and in direction 411, and the leg angular adjustment adapter 400 can include hard stop 403 that is configured to prevent further rotation of the respective leg 110 or 111 relative to the ground surface 11 and foundation component 105 in each of the directions 410 and 411. FIG. 4C is an elevational view of the leg 110 of the multi-leg solar tracker support frame 102 with the leg angular adjustment adapter 400 hard-stopped at a preset angular orientation relative to ground surface 11. FIG. 4D is an elevational view of an adapter component 402 having an embodiment of a hard stop 403. FIG. 4E is an elevation view showing the leg 110 of the multi-leg solar tracker support frame 102 with the leg angular adjustment adapter 400 hard-stopped at a preset angular orientation relative to ground surface 11 via the hard stop 403 at the adapter component 402

The illustrated embodiment of the hard stop 403 shows the hard stop 403 included at the adapter component 402. The hard stop 403 can be configured to impede or prevent further rotation of the leg 110 or 111 when the leg 110 or 111 is at a present angular orientation relative to the ground surface 11. For example, the leg angular adjustment adapter 400 can be configured to provide hard stop 403 against the foundation connector 405 such that when the respective first frame leg 110 or second frame leg 111 is rotated to a preset angular orientation relative to the ground surface 11, the hard stop 403 is configured to impede or prevent further rotation of the leg 110 or 111 as a result of interference at the foundation connector 405 upon contact between the foundation connector 405 and the hard stop 403.

The hard stop 403 can include first hard stop 403A and second hard stop 403B spaced apart from first hard stop 403A at the adapter component 402. The first hard stop 403A can be at one side of the adapter component 402 and the second hard stop 403B can be at another, opposite side of the adapter component 402. The first hard stop 403A can be configured to impede or prevent further rotation of the leg 110 in the direction 410. For example, the first hard stop 403A can be configured to impede or prevent further rotation of the leg 110 in the direction 410 when the leg 110 is at a preset angular orientation 420 of two degrees, three degrees, four degrees, five degrees, or ten degrees. The present angular orientation can be defined as an angle between a central longitudinal axis 424 of the foundation component 405 and a central longitudinal axis 426 of the leg 110. The second hard stop 403B can be configured to impede or prevent further rotation of the leg 110 in the direction 411. For example, the second hard stop 403B can be configured to impede or prevent further rotation of the leg 110 in the direction 411 when the leg 110 is at a preset angular orientation 420 of two degrees, three degrees, four degrees, five degrees, or ten degrees. Again, the present angular orientation can be defined as an angle between a central longitudinal axis 424 of the foundation component 105 and a central longitudinal axis 426 of the leg 110.

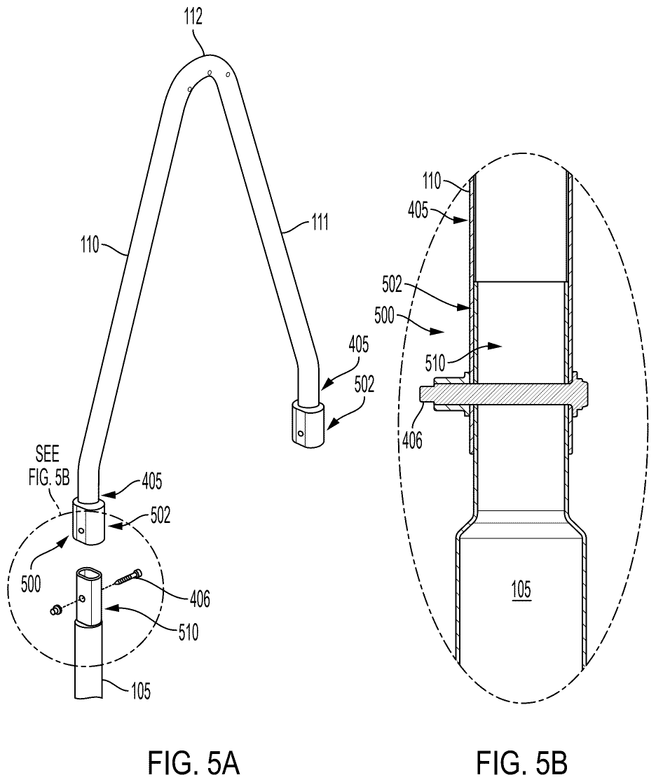

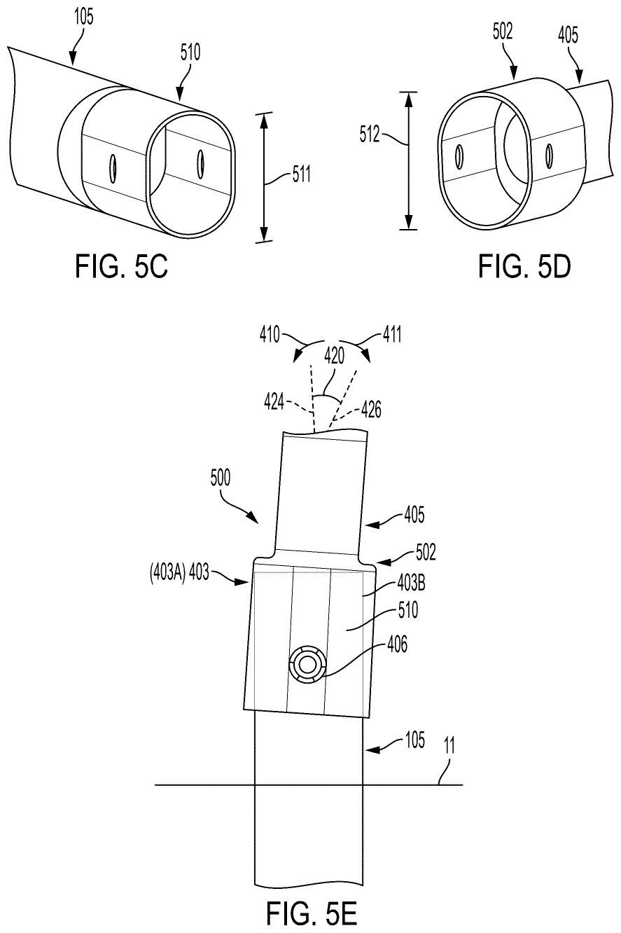

FIGS. 5A-5E illustrate another exemplary embodiment of a leg angular adjustment adapter 500 at leg 110 of multi-leg solar tracker support frame 102 of solar tracker support frame assembly 100. For certain embodiments of the leg angular adjustment adapter 500, the leg angular adjustment adapter 500 can be similar to, or the same as, the leg angular adjustment adapter 400 disclosed previously except as otherwise noted here. For instance, the leg angular adjustment adapter 500 can be similar to, or the same as, the leg angular adjustment adapter 400 disclosed previously but that the leg angular adjustment adapter 500 removes the separate, distinct adapter component 402 and instead includes in its place a hinged adapter component 502 that is integrated at the foundation connector 405.

FIG. 5A is an exploded, assembly view of the leg angular adjustment adapter 500 at the leg 110 of the multi-leg solar tracker support frame 102. FIG. 5B is a perspective view of the leg angular adjustment adapter 500 assembled at foundation component 105 using foundation connector 405 at the leg 110 of the multi-leg solar tracker support frame 102. FIG. 5C is a perspective view of an end portion of foundation component 105 having a complementary connector 510, and FIG. 5D is a perspective view of the foundation connector 405 at the leg 110 of the multi-leg solar tracker support frame 102 having the leg angular adjustment adapter 500. FIG. 5E is an elevational view showing the leg 110 of the multi-leg solar tracker support frame 102 with the foundation connector 405 at the leg 110 hard-stopped at preset angular orientation 420 relative to ground surface 11 via hard stop 403 at the complementary connector 510 of the foundation component 105.

The leg angular adjustment adapter 500 can be configured to change an angular orientation of the at least one of the first frame leg 110 and the second frame leg 111 relative to ground surface 11. For example, the leg angular adjustment adapter 500 can be configured to change the angular orientation of the at least one of the first frame leg 110 and the second frame leg 111 relative to the ground surface 11 in a north-south direction relative to the ground surface 11. For instance, referring to FIG. 1, the leg angular adjustment adapter 500 can be included at the leg 110 and/or leg 111 of any one or more of the multi-leg solar tracker support frames 102A, 102B, 102D, 102E to change the angular orientation of the at least one of the first frame leg 110 and the second frame leg 111 relative to the ground surface 11 in a north-south direction relative to the ground surface 11.

The illustrated embodiment of the leg angular adjustment adapter 500 includes hinged adapter component 502 that is integrated at the foundation connector 405. The hinged adapter component 502 can be configured to rotatably couple the leg 110 or 111 to the foundation component 105. As shown at the example at FIGS. 5C and 5D, the foundation component 105 can include the complementary connector 510 having a first width 511, and the foundation connector 405 at the leg 110 and/or 111 can include the hinged adapter component 502 having a second width 512. The illustrated embodiment of the leg angular adjustment adapter 500 has the second width 512 of the hinged adapter component 502 greater than the first width 511 of the complementary connector 510. Referring to the example at FIG. 5E, the hinged adapter component 502 can be seated over the complementary connector 510 and extend around the complementary connector 510 to hingedly connect the hinged adapter component 502 to the complementary connector 510 (e.g., via pin 406). The hinged adapter component 502 can rotate relative to the complementary connector 510, and thus relative to the foundation component 105, in directions 410 and 411. When the hinged adapter component 502 so rotates in the direction 410 to a preset angular orientation, hard stop 403B at the complementary connector 510 can be configured to impede or prevent further rotation of the leg 110 or 111 in the direction 410 via interference contact between the hard stop 403B, at the complementary connector 510, and an interior surface at the hinged adapter component 502. Similarly, when the hinged adapter component 502 so rotates in the direction 411 to preset angular orientation 420, hard stop 403A at the complementary connector 510 can be configured to impede or prevent further rotation of the leg 110 or 111 in the direction 411 via interference contact between the hard stop 403A, at the complementary connector 510, and an interior surface at the hinged adapter component 502.

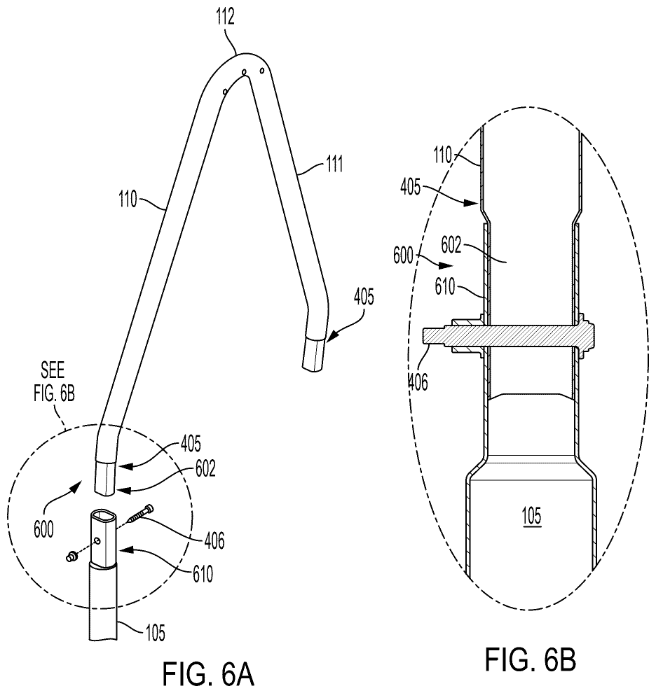

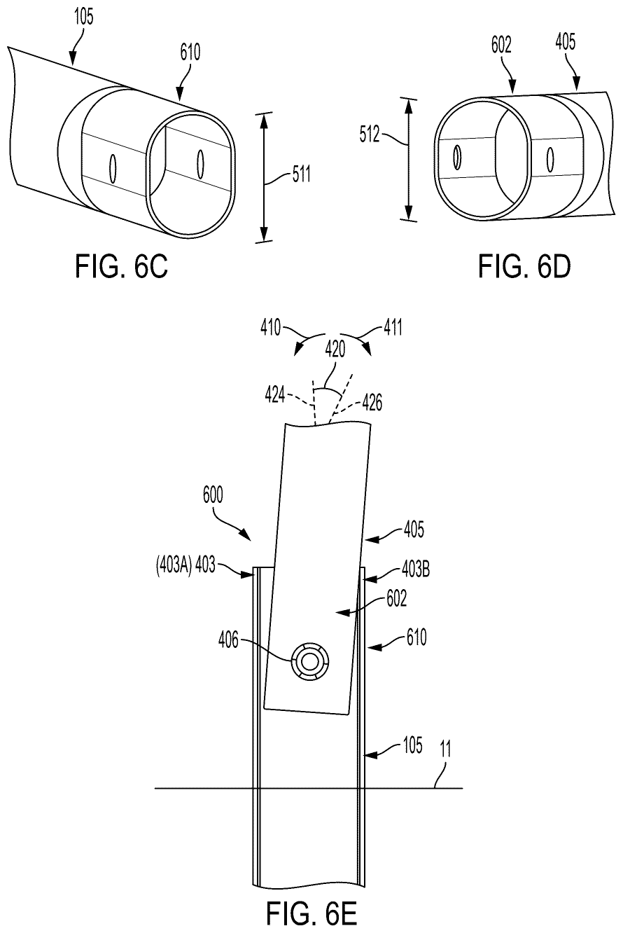

FIGS. 6A-6E illustrate another exemplary embodiment of a leg angular adjustment adapter 600 at leg 110 of multi-leg solar tracker support frame 102 of solar tracker support frame assembly 100. For certain embodiments of the leg angular adjustment adapter 600, the leg angular adjustment adapter 600 can be similar to, or the same as, the leg angular adjustment adapter 400 disclosed previously except as otherwise noted here. For instance, the leg angular adjustment adapter 600 can be similar to, or the same as, the leg angular adjustment adapter 400 disclosed previously but that the leg angular adjustment adapter 600 removes the separate, distinct adapter component 402 and instead includes in its place a hinged adapter component 602 that is integrated at the foundation connector 405. More specifically, the leg angular adjustment adapter 600 can be similar to, or the same as, the leg angular adjustment adapter 500 disclosed previously, which has a larger width at the hinged adapter component 502, but that the leg angular adjustment adapter 600 can instead have a larger width at the complementary connector 610 and smaller width at the hinged adapter component 602.

FIG. 6A is an exploded, assembly view of the leg angular adjustment adapter 600 at the leg 110 of the multi-leg solar tracker support frame 102. FIG. 6B is a perspective view of the leg angular adjustment adapter 600 assembled at foundation component 105 using foundation connector 405 at the leg 110 of the multi-leg solar tracker support frame 102. FIG. 6C is a perspective view of an end portion of foundation component 105 having complementary connector 610, and FIG. 6D is an end portion perspective view of hinged adapter component 602 at the foundation connector 405 at the leg 110 of the multi-leg solar tracker support frame 102. FIG. 6E is an elevational view showing the leg 110 of the multi-leg solar tracker support frame 102 with the foundation connector 405 at the leg 110 hard-stopped at preset angular orientation 420 relative to ground surface 11 via hard stop 403 at the complementary connector 610 of the foundation component 105.

The leg angular adjustment adapter 600 can be configured to change an angular orientation of the at least one of the first frame leg 110 and the second frame leg 111 relative to ground surface 11. For example, the leg angular adjustment adapter 600 can be configured to change the angular orientation of the at least one of the first frame leg 110 and the second frame leg 111 relative to the ground surface 11 in a north-south direction relative to the ground surface 11. For instance, referring to FIG. 1, the leg angular adjustment adapter 600 can be included at the leg 110 and/or leg 111 of any one or more of the multi-leg solar tracker support frames 102A, 102B, 102D, 102E to change the angular orientation of the at least one of the first frame leg 110 and the second frame leg 111 relative to the ground surface 11 in a north-south direction relative to the ground surface 11.

The illustrated embodiment of the leg angular adjustment adapter 600 includes hinged adapter component 602 that is integrated at the foundation connector 405. The hinged adapter component 602 can be configured to rotatably couple the leg 110 or 111 to the foundation component 105. As shown at the example at FIGS. 6C and 6D, the foundation component 105 can include the complementary connector 610 having first width 511, and the foundation connector 405 at the leg 110 and/or 111 can include the hinged adapter component 602 having second width 512. The illustrated embodiment of the leg angular adjustment adapter 600 has the second width 512 of the hinged adapter component 502 less than the first width 511 of the complementary connector 510. Referring to the example at FIG. 6E, the hinged adapter component 602 can be seated within the complementary connector 610 and extend around and interface with an interior surface at the complementary connector 610 to hingedly connect the hinged adapter component 602 to the complementary connector 610 (e.g., via pin 406). The hinged adapter component 602 can rotate relative to the complementary connector 610, and thus relative to the foundation component 105, in directions 410 and 411. When the hinged adapter component 602 so rotates in the direction 410 to a preset angular orientation, hard stop 403B at the complementary connector 610 can be configured to impede or prevent further rotation of the leg 110 or 111 in the direction 410 via interference contact between the hard stop 403B, at the complementary connector 610, and an interior surface at the hinged adapter component 602. Similarly, when the hinged adapter component 602 so rotates in the direction 411 to preset angular orientation 420, hard stop 403A at the complementary connector 610 can be configured to impede or prevent further rotation of the leg 110 or 111 in the direction 411 via interference contact between the hard stop 403A. at the complementary connector 610, and an interior surface at the hinged adapter component 602.

Various examples have been described. These and other examples are within the scope of the following claims.

What is claimed is:

1. A solar tracker support frame assembly comprising:
a multi-leg solar tracker support frame comprising a first frame leg, a second frame leg, and a bridge extending between the first frame leg and the second frame leg; and
a hanging bearing housing assembly at the multi-leg solar tracker support frame and configured to support a torque tube, the hanging bearing housing assembly comprising a bearing sleeve and a torque tube connector,
wherein the bearing sleeve comprises a first bearing sleeve portion and a hanging bearing sleeve portion, the first bearing sleeve portion interfacing with the bridge, the hanging bearing sleeve portion extending out from the first bearing sleeve portion below the bridge, and
wherein the torque tube connector is configured to couple the torque tube to the hanging bearing housing assembly at least at the hanging bearing sleeve portion below the bridge.

2. The assembly of claim 1, wherein the first bearing sleeve portion wraps around at least a portion of the bridge.

3. The assembly of claim 2, wherein the first bearing sleeve portion wraps around at least half of a perimeter surface of the bridge.

4. The assembly of claim 2, wherein the hanging bearing sleeve portion comprises a first hanging bearing sleeve portion at a first side of the bridge and a second hanging bearing sleeve portion at a second, opposite side of the bridge.

5. The assembly of claim 4, wherein the first hanging bearing sleeve portion comprises a first torque tube connector aperture at the first side of the bridge and the second hanging bearing sleeve portion comprises a second torque tube connector aperture at the second, opposite side of the bridge.

6. The assembly of claim 5, wherein the first torque tube connector aperture at the first side of the bridge and the second torque tube connector aperture at the second, opposite side of the bridge are aligned on a connector aperture axis.

7. The assembly of claim 6, wherein the torque tube connector comprises a pin.

8. The assembly of claim 7, further comprising:
a U-bolt that couples the pin to the torque tube.

9. The assembly of claim 8,
wherein the pin extends through the first torque tube connector aperture at the first side of the bridge and the second torque tube connector aperture at the second side of the bridge, and
wherein the pin couples to a pin aperture at the U-bolt.

10. The assembly of claim 7, wherein the pin extends along a pin longitudinal axis that is offset from a longitudinal axis of the torque tube.

11. The assembly of claim 6, wherein the torque tube connector comprises a bearing housing that defines a torque tube receptacle extending through the bearing housing from the first torque tube connector aperture at the first side of the bridge to the second torque tube connector aperture at the second side of the bridge.

12. The assembly of claim 11, wherein the bearing housing extends below the bridge to suspend the torque tube receptacle below the bridge.

13. The assembly of claim 5, wherein the first bearing sleeve portion includes a yaw interface that is configured to twist the bearing sleeve relative to the bridge.

14. The assembly of claim 5, wherein the first bearing sleeve portion defines an apex at the multi-leg solar tracker support frame.

15. The assembly of claim 1, wherein at least one of the first frame leg and the second frame leg comprises a leg angular adjustment adapter, the leg angular adjustment adapter configured to change an angular orientation of the at least one of the first frame leg and the second frame leg relative to a ground surface.

16. The assembly of claim 15, wherein the leg angular adjustment adapter is configured to change the angular orientation of the at least one of the first frame leg and the second frame leg relative to the ground surface in a north-south direction relative to the ground surface.

17. The assembly of claim 16, wherein each of the first frame leg and the second frame leg comprise the leg angular adjustment adapter.

18. The assembly of claim 17, wherein each of the first frame leg and the second frame leg comprise a foundation connector that is configured to couple to a foundation component embedded in the ground surface, and wherein the leg angular adjustment adapter is at the foundation connector at each of the first frame leg and the second frame leg.

19. The assembly of claim 18, wherein the leg angular adjustment adapter is configured to provide a hard stop at the foundation connector when the respective first frame leg and second frame leg is at a preset angular orientation relative to the ground surface.

20. A hanging bearing housing assembly configured to support a torque tube, the hanging bearing housing assembly comprising:
a bearing sleeve comprising a first bearing sleeve portion and a hanging bearing sleeve portion, the first bearing sleeve portion configured to define an apex at a multi-leg solar tracker support frame when the hanging bearing housing assembly is coupled to the multi-leg solar tracker support frame, the hanging bearing sleeve portion extending out below the first bearing sleeve portion when the hanging bearing housing assembly is coupled to the multi-leg solar tracker support frame; and
a torque tube connector, the torque tube connector configured to couple the torque tube to the hanging bearing housing assembly at the hanging bearing sleeve portion below the bridge.
